(19) United States
(12) Patent Application Publication
(10) Pub. No.: US 2025/0127330 A1
(43) Pub. Date: Apr. 24, 2025

(54) DOUBLE-WALLED GRILL DEVICE

(71) Applicant: Burnhard GmbH, Düsseldorf (DE)

(72) Inventors: Max Ruhfus, Düsseldorf (DE); Maximilian Roth, Düsseldorf (DE); Niklas Strohfeld, Düsseldorf (DE); Weiyi Zhang, Düsseldorf (DE)

(21) Appl. No.: 18/923,488

(22) Filed: Oct. 22, 2024

(30) Foreign Application Priority Data
Oct. 23, 2023 (EP) 23205116.9

(51) Int. Cl. A47J 37/07

(52) U.S. Cl. CPC A47J 37/0713; A47J 37/0786

(57) ABSTRACT

A double-walled grill device comprising:
a trough-shaped outer housing chamber open at the top; and
a trough-shaped inner grill chamber open at the top;
   wherein the inner grill chamber is designed to receive at least one burner device and the inner grill chamber is designed to be arranged within the outer housing chamber; and
   wherein, when the inner grill chamber is arranged within the outer housing chamber, at least a first intermediate space through which air can flow is formed between the inner grill chamber and the outer housing chamber.

This application claims priority to European Patent Application No. 23205116.9, filed Oct. 23, 2023, which is incorporated herein by reference in its entirety.

The present invention relates to a double-walled grill device for preparation.

A large number of grill devices are already known from prior art, which usually have a grill chamber, a housing and a burner device. The housing surrounds the grill chamber, spatially separating a grill area in the grill chamber from the surroundings on the one hand and protecting the food arranged in the grill chamber, also known as grilled food, from environmental influences on the other.

The burner device is arranged inside the grill chamber and generates a combustion process, for example by burning a gas, so that a sufficiently high temperature is generated inside the grill chamber to heat the food. The temperatures generated by the burner device generally exceed several 100° C., so that in addition to the inside of the grill chamber, the walls of the housing of the grill devices known from prior art are also heated to a high temperature. The disadvantage of the prior art is that a large proportion of the thermal energy introduced via the burner device is lost through the walls of the grill device, making the grill process energy-inefficient and resulting in increased gas consumption. The present invention is not intended to be limited to the field of gas-powered burner devices; rather, the burner devices can also be provided for heating the grill chamber by means of electrical energy, for example, or alternatively by using other fuels such as wood or coal.

Another disadvantage of prior art grill devices is that they are difficult and time-consuming to clean. For example, the grill devices of the prior art predominantly have a grill chamber that is joined with a material bond or joined with a force fit by means of a large number of screws or rivets, whereby individual areas of the grill chamber are only accessible or separable or removable for cleaning purposes by a user with increased effort or not at all. Complete and hygienic cleaning of the grill chambers using prior art technology is therefore not possible or only possible with great effort. Furthermore, due to the elaborately joined grill chambers, it is not possible, or only possible with increased effort, to replace individual areas or elements for maintenance purposes, for example. This means, for example, that a user cannot simply replace a grill chamber that has been damaged in one area due to intensive use and must therefore purchase a completely new grill device. The grill devices of the prior art are therefore only sustainable to a limited extent.

Based on the described disadvantages of the grill devices known from prior art, it is therefore the object of the present invention to provide a double-walled grill device which has an increased efficiency, in particular uses the thermal energy generated by the burner device more effectively and which is designed in such a way that individual components can be replaced for cleaning and/or maintenance purposes without great effort.

According to a first aspect, the present invention relates to a double-walled grill device.

The double-walled grill device according to the invention comprises:
an upwardly open trough-shaped outer housing chamber, and
an inner grill chamber that is open at the top,
   wherein the inner grill chamber is designed to receive at least one burner device and the inner grill chamber is designed to be arranged within the outer housing chamber, and
   wherein, when the inner grill chamber is arranged within the outer housing chamber, at least a first intermediate space through which air can flow is formed between the inner grill chamber and the outer housing chamber.

The double-walled grill device according to the invention has a trough-shaped outer housing chamber that is open at the top. The trough-shaped outer housing chamber can be hemispherical, basin-shaped or bowl-shaped, for example. The housing chamber may thus also have an arcuate shape only in the area of specific parts. The aforementioned embodiments have the advantage that the correspondingly designed housing chamber can also be adapted to round parts of a grill device, such as a kettle grill or kamado grill, and can be provided therein. Consequently, the double-walled grill chamber according to the invention is not limited to rectangular embodiments of grill chambers.

The same applies analogously to the upward-opening trough-shaped inner grill chamber, so that the trough-shaped outer housing chamber and the trough-shaped inner grill chamber preferably have the same or at least a similar shape.

The inner grill chamber is designed to accommodate at least one burner device, so that the burner device can preferably be stored in or on the inner grill chamber and can be fixed relative to the same. Within the scope of the invention, the burner device can, for example, be designed as a ceramic burner, a wok burner, an infrared burner or a gas burner. Of course, the inner grill chamber can also be designed to accommodate a plurality of burner devices, with the burner devices differing from one another.

Since the inner grill chamber is designed to be arranged inside the outer housing chamber, the at least one burner device is preferably also arranged inside the outer housing chamber. In other words: The outer housing chamber completely surrounds the inner grill chamber and preferably the at least one burner device.

According to the invention, when the inner grill chamber is arranged within the outer housing chamber, at least a first intermediate space through which air flows is formed between the inner grill chamber and the outer housing chamber. In the context of the invention, the flow through the intermediate space can also be understood as the circulation of air masses within the intermediate space.

If the double-walled grill device is in operation, so that the at least one burner device performs a combustion process, temperatures of several 100° C. can be generated inside the upwardly open trough-shaped inner grill chamber. The high temperatures that are transferred from the burner device towards the inner grill chamber lead to heating of the trough-shaped inner grill chamber. Since the first intermediate space through which air can flow is formed between the inner grill chamber and the outer housing chamber according to the invention, this intermediate space acts as an insulator, so that the temperature from the inner grill chamber is transferred to the outer housing chamber only to a small extent.

The insulation process is based on the fact that air, or gas, is a poor thermal conductor. This means that the air trapped or flowing between the outer housing chamber and the inner grill chamber allows comparatively low heat transfer.

As air can flow through the intermediate space, the air heated by the inner grill chamber can still be advantageously removed by an air flow between the inner grill chamber and the outer grill chamber. In other words: The first intermediate space through which air can flow transports the heat between the inner grill chamber and the outer housing chamber in an advantageous manner, so that the outer housing chamber has a preferably low temperature. However, the advantageously low temperature of the outer housing chamber is also ensured if air only circulates within the intermediate space or is arranged in it, as the air acts as a natural insulator. The supply of air from the surroundings of the grill chamber, which is colder than the warm air present in the cavity, also causes a reduction of the heating of the outer housing chamber.

Due to the comparatively much colder outer housing chamber, the double-walled grill device can be positioned in temperature-sensitive areas, such as in the immediate vicinity of a house wall, without any problems during operation. Furthermore, the intermediate space between the inner grill chamber and the outer housing chamber, through which air can flow, preferably keeps the thermal energy emitted by the burner device within the inner grill chamber, so that the double-walled grill device according to the invention is configured to be particularly energy-efficient. In addition, due the comparatively much colder outer housing chamber, there is virtually no risk of burns for the user if he comes into contact with the outer housing chamber. The double-walled grill device according to the invention is therefore particularly safe, for example if children touch the outer housing chamber carelessly or accidentally at an unobserved moment.

In a preferred embodiment, it is provided that the outer housing chamber comprises at least one outer side element and at least one outer base element and/or that the inner grill chamber comprises at least one inner side element and at least one inner base element. The at least one outer side element and the at least one outer base element can be connected to one another in a form-fitting manner the same as the at least one inner side element and the at least one inner base element. Due to the fact that the outer housing chamber and the inner grill chamber have the aforementioned elements, these can be easily replaced. This means, for example, that an inner base element can be advantageously cleaned without having to clean the entire grill device. For example, the inner base element can be cleaned manually or by using a dishwasher for user-friendly cleaning.

In addition, the grill device according to the invention, in which the outer housing chamber and the inner grill chamber comprise a plurality of elements, can be assembled or disassembled in a particularly advantageous manner, so that the double-walled grill device can be stowed away in a particularly space-saving manner, for example for storage and/or transportation purposes.

It is preferable that the outer side element can be connected to the outer base element and/or that the inner side element can be connected to the inner base element. In the context of the present invention, the term “connectable” is understood to mean the possibility of connecting different elements to one another in a positive and/or force-fit manner. For example, the outer side element and the outer base element can be connected to each other via a plug-in connection. In this case, the outer side element can, for example, have projections that protrude into openings in the outer base element and thus create a positive connection. Of course, such a plug-in connection can also be present between the inner side element and the inner base element. Additionally or alternatively, the connection can also be made using studs, pins and/or bolts. Due to the fact that the outer side element can be connected to the outer base element and/or the inner side element can be connected to the inner base element, the double-walled grill device according to the invention can be assembled or disassembled particularly easily, for example for cleaning, maintenance and/or storage purposes.

In a preferred embodiment, it is provided that the outer housing chamber has at least one ventilation inlet for supplying cold air into the first intermediate space. The at least one ventilation inlet for supplying cold air is preferably arranged in a lower or central area of the grill chamber. Such an arrangement allows the incoming cold air flow to absorb heat energy emitted from the inside of the grill chamber and then transport it towards an upper area of the housing chamber. The heated cold air thus flows or circulates through the gap. By arranging the ventilation inlet below an area for heat dissipation, a kind of chimney effect can be advantageously established in the intermediate space for the supply of cold air surrounding the outer chamber and the removal of heated air present in the intermediate space. The cold air supplied is preferably ambient air, so that ambient air flows through the intermediate space. The at least one ventilation inlet in the outer housing chamber enables the air heated in the intermediate space to be removed or circulated, so that the outer housing chamber is advantageously cooled by the supplied cold air. The outer housing chamber therefore has a comparatively much lower temperature than the inner grill chamber.

Optionally, the at least one ventilation inlet is designed as an air scoop. The air scoop is a ventilation inlet that has protrusions through which a cold air flow can be directed into the interior of the outer housing chamber. Comparatively more ambient air is captured via the protrusions, so that the inflowing cold air flow is directed particularly advantageously into the space between the outer housing chamber and the inner grill chamber by the at least one ventilation inlet designed as an air scoop. The outer housing chamber is thus cooled particularly effectively by means of the air inlet designed as an air scoop. The air scoop also has the advantage that the provision of the projection prevents a direct air flow along a straight path via the air inlet, as the air flow must be diverted by the design of the scoop in order to be able to flow into the intermediate space through the air inlet.

In a preferred embodiment, it is provided that the outer housing chamber has at least one opening in the outer base element and/or the inner grill chamber has at least one opening in the inner base element, in particular at least one outlet opening, respectively. The at least one outlet opening can preferably be designed as a drainage opening so that, for example, moisture or liquid residues that arise during a grilling process can flow out of the inner grilling chamber and/or the outer housing chamber. The moisture may be, for example, a cleaning liquid that has been introduced into the grill device for cleaning purposes, and a liquid grease that has accumulated in the grill device during a grilling operation may be regarded as a liquid residue, for example. Such residues or liquids can then accumulate on the inner base element of the inner grill chamber and be led out through the at least one outlet opening and/or accumulate on the outer housing chamber and flow out of the grill device via the outlet opening in the outer base element. The residues can thus drain away particularly advantageously, so that no undesirable residues accumulate inside the inner grill chamber and/or inside the outer housing chamber of the grill device. By draining the liquid fat from the inner grill chamber, a possible fat fire is also prevented in an advantageous manner. The grill device according to the invention is thus kept clean in a particularly advantageous manner even when used intensively.

Optionally, a container can be arranged below the at least one outlet opening, wherein the container can preferably be designed as a fat drawer. The residues, such as liquid fat, which flow out of the outlet opening during or after a grilling process, are thus collected in the designed container. The designed container can be arranged below the at least one outlet opening by means of a positive connection, such as a type of bayonet lock, and can be mounted so that it can be slidably supported by a rail guide. The unwanted fat or other grilling residues separated during the grilling process can therefore be conveniently collected and disposed of in the container designed as a fat drawer.

In a preferred embodiment, it is provided that the inner side element and/or the inner base element has/have a plurality of wall elements via which the inner grill chamber can be supported at a distance in the outer housing chamber. The plurality of wall elements create a defined distance between the inner grill chamber and the outer housing chamber, so that the at least one space through which air can flow is defined. The dimensions of the plurality of wall elements can be used to adjust the spatial extent and shape of the space through which the air can flow, so that the flow behavior of the air flowing through the space can be influenced. For example, the plurality of wall elements can be used to adapt the space between the inner grill chamber and the outer housing chamber in areas of increased temperature so that the air flowing past the areas of increased temperature flows in such a way that the heat energy leaving the areas with increased temperature is preferentially transported away by the influenced flow behavior. The plurality of wall elements can therefore be used to influence the flow behavior of the air flowing through the flow-through intermediate space in an advantageous way. The first intermediate space, through which air can flow, is thus designed to be particularly energy-efficient due to the plurality of wall elements.

Advantageously, it can be provided that air baffles protruding into the intermediate space are arranged on the inner grill chamber and/or on the outer housing chamber in order to thus preferably guide an air flow within the intermediate space.

Optionally, it is provided that the inner grill chamber and/or the several side elements of the inner grill chamber and/or the inner base element can be connected to the outer housing chamber via guide elements. Such guide elements can be, for example, protrusions, guide pins and/or guide rails, which are arranged on the inner grill chamber and/or on the outer housing chamber. The guide elements connect the inner grill chamber to the outer housing chamber in such a way that the inner grill chamber is arranged inside the outer housing chamber with virtually no play. The connection via the guide elements can preferably be form-fit, so that the inner grill chamber can be detached from the outer housing chamber particularly easily. As a result, the inner grill chamber and the outer housing chamber can be separated from each other particularly easily, for example for cleaning and/or maintenance purposes.

In a preferred embodiment, it is provided that the outer housing chamber and/or the inner grill chamber enclose a grill chamber space that becomes larger in the vertical direction towards the top. In the context of the invention, the term “upwards” is to be understood as the direction against gravity, whereas the term “downwards” is to be understood as in the direction of gravity. As the grill chamber space increases in size vertically upwards, individual walls of the housing chamber and/or the grill chamber are not aligned perpendicular to the horizontal, so that fat and/or other liquids that accumulate during a grilling process can flow in the direction of gravity, i.e. downwards, into the grill chamber space. The grill chamber space, which becomes larger towards the top, is thus particularly advantageous for the drainage of fat and/or other liquids, so that undesirable accumulations of fat and/or liquids are advantageously reduced in the double-walled grill device according to the invention. A permanent remaining of fat and/or liquids, which dry out or even thermally decompose under the influence of heat from the burner device, is prevented by the design provided.

Preferably, at least one insulating part is arranged on the outer housing chamber, with at least a second intermediate space through which air can flow being formed between the at least one insulating part and the outer housing chamber. The at least one insulating part and the outer housing chamber thus enclose at least a second intermediate space through which air can flow, so that the insulating part constitutes a further wall. Thanks to the second intermediate space through which air can flow, the double-walled grill device therefore has further thermal insulation, so that the outer housing chamber is further thermally insulated from the inner grill chamber. The heating of the outer housing chamber is thus reduced particularly advantageously by the at least one additional insulating part.

Optionally, it is provided that the at least one insulating part has ventilation elements for the additional supply of cold air into the at least one second intermediate space. The ventilation elements thus supply the at least one second intermediate chamber with cold air or ambient air, so that an exchange between fresh cold air flowing in from outside and air heated by the grilling process is ensured in the second intermediate chamber. The ventilation elements can be designed as air scoops, slits or openings. The at least one second intermediate space is thus supplied with fresh cold air in a particularly advantageous way via the ventilation elements and reduces the heating of the outer housing chamber.

Preferably, it is provided that the inner base element is arranged to rise from a central area in the direction of the inner side element and/or the outer base element is arranged to rise from a central area in the direction of the outer side element. The inner base element and/or the outer base element are therefore arranged to be inclined downwards. The outer housing chamber, which comprises the at least one outer base element, and the inner grill chamber, which comprises the at least one inner base element, are thus funnel-shaped. The arrangement of the inner base element and/or the outer base element rising from a central area causes deposits and/or moisture and/or grease residues that are produced during the grilling process and that accumulate or are deposited on an inner side element, on the inner base element and/or on the outer side element and the outer base element to flow towards the central area due to the inclination. Furthermore, during a cleaning process of the double-walled grill device, a cleaning lotion can flow, due to the inclination, from the inner side element and/or the outer side element via the inner base element and/or the outer base element towards the central area, so that the double-walled grill device is particularly easy to clean. Furthermore, due to the inclination, unwanted residues from the grilling process also flow advantageously towards the center area, so that an unwanted accumulation of residues from the grilling process in an uninclined area is advantageously avoided.

In a preferred embodiment, it is provided that the inner grill chamber comprises at least one first recess for fixing and at least one first opening for floatingly supporting at least one burner device, wherein the at least one first recess and the at least one first opening are arranged opposite each other. In this case, the at least one first recess for fixing the burner device can be arranged in a side of the grill device facing away from the user, and the at least one first opening for floating mounting can preferably be arranged in a side of the grill device facing the user. Since the at least one burner device is mounted floating, it is on the one hand arranged in a radially stable manner in the grill device and on the other hand arranged with sufficient axial play, so that the burner device is not jammed in the grill device even due to material-related expansion at higher temperatures. Furthermore, the recess makes it particularly easy to remove the burner device from the grill device, for example for cleaning and/or maintenance purposes.

Preferably, it is provided that the outer housing chamber has at least one second opening, wherein preferably the at least one second opening is adapted to the at least one first opening for a floating mounting of the at least one burner device of the inner wall. Due to the second opening in the outer housing chamber, the at least one burner chamber, which is floatingly mounted in the first opening of the inner wall, can be guided through the first and second openings. The at least one burner device can thus be integrated particularly easily into the double-walled grill device and can also be operated particularly easily by a user from outside the outer housing chamber. The burner device can be operated, for example, via a controller, which can also be arranged on the at least one second opening and/or on the burner device protruding from the second opening. Furthermore, the adaptation of the second opening of the outer housing chamber to the first opening of the inner wall of the inner grill chamber has proven to be particularly visually appealing.

It is optionally provided that the inner grill chamber has at least a second recess and/or a holding element for receiving a flame shielding device. The second recess and/or the holding element can be formed on opposite side elements of the inner grill chamber. The flame shielding device can also be designed as an aroma bar, which is arranged above the burner device and attached via a split pin, for example. The second recess and/or the holding element allow the inner grill chamber and thus the grill device according to the invention to be extended in a particularly simple manner, for example with a flame shielding device.

Preferably, a cover is pivotably arranged on the outer housing chamber to partially or completely cover the upper opening of the inner grill chamber and/or the outer housing chamber. The cover can preferably be arranged on two opposite sides of the trough-shaped outer housing chamber. The cover can have instruments for displaying temperature, pressure and/or humidity for areas of the inner grill chamber or in areas below the cover The upper opening of the inner grill chamber and/or the outer housing chamber can thus be partially or completely covered by a user particularly easily via the hinged cover, so that heat loss during a grilling process is advantageously avoided. The grill device according to the invention can therefore be operated in a particularly energy-efficient manner. Furthermore, the cover on the outer housing chamber can also be used to protect the grilled food from environmental influences during the grilling process.

In a preferred embodiment, it is provided that the cover has at least one double-walled wall having a further intermediate space, the further intermediate space preferably being filled with an insulating material. Such an insulating material can be a mineral wool suitable for high-temperature insulation, for example, so that the temperature below the cover is not conducted to the outside through the insulating material arranged in the double-walled wall. Of course, within the scope of the invention, certain areas of the first and/or second intermediate space through which air can flow can also be filled with insulating material. The cover, which comprises a double-walled wall with insulating material, allows the grill device according to the invention to be operated in a particularly efficient and resource-saving manner.

Optionally, it is provided that the cover has at least one outlet for discharging a hot air flow from the inner grill chamber and/or outer housing chamber and/or from the at least one first intermediate chamber. The outlet can be designed as a hole or a slot, for example, and can be arranged in an upper area, a rear area or a side area of the hinged cover. The outlet can also have a closing mechanism so that the outlet can be closed if required. A hot air flow from an area underneath the cover or from the inner grill chamber and/or from the outer housing chamber can be discharged via the outlet, so that the temperature in the area underneath the cover or in the inner grill chamber can be regulated in an advantageous manner via the outlet. If, for example, a very high temperature is required for a short time for special grilling applications, the outlet can be closed via the closing mechanism so that the temperature in the inner grill chamber rises briefly and then falls again when the outlet is opened by the closing mechanism. The temperature of the grill device according to the invention can thus be regulated via the at least one outlet in the hinged cover.

Optionally, the outer housing chamber has upwardly projecting shielding elements. Such shielding elements can, for example, be arranged on the side areas and/or on a rear area of the outer housing chamber, so that the outer housing chamber and the inner grill chamber are shielded from environmental influences in a particularly advantageous way.

It is optionally provided that the inner grill chamber has at least one inwardly projecting projection and/or a recess at an upper edge area for supporting a grid, a plancha and/or a grill plate. The grid, the plancha and/or the grill plate can rest on the inwardly projecting projection so that they can be temporarily removed particularly easily by a user, for example for cleaning purposes. Additionally or alternatively, the grid, the plancha and/or the grill plate can also rest on a recess in the upper edge area of the inner grill chamber, so that they can be hung into the recess using projections or pins arranged on them, for example. In principle, the grill plate and the grid can also be made in several parts and then rest on a plurality of inwardly projecting projections. Of course, the grill device according to the invention can also have a combination of at least one inwardly projecting projection and at least one recess. Due to the at least one inwardly projecting projection and/or the at least one recess, the grid, the plancha and/or the grill plate can thus be integrated into the grill device according to the invention in a particularly simple manner and can be removed and/or replaced particularly easily if necessary.

Optionally, a rear burner is provided above and along an edge area of the outer housing chamber and/or the inner grill chamber. In the context of the present invention, the rear burner should also be understood as a back burner and can supply the inner grill chamber with thermal energy in addition to or as an alternative to the burner device. By arranging the rear burner, a particularly temperature-intensive grilling process can thus be achieved along an edge area of the outer housing chamber, so that the food to be grilled, which is arranged in this area, is additionally supplied with heat energy on the longitudinal side in a particularly advantageous way.

In a preferred embodiment, it is provided that a control panel with additional ventilation inlets is arranged outside the outer housing chamber. The control panel can be arranged on the front of the grill device on a side facing the user and have various operating elements such as rotary controls and/or ignition buttons. Thanks to the ventilation inlets, the high temperature that prevails in the inner grill chamber during a grilling process is transferred to the control panel only to a limited extent. The ventilation inlets on the control panel allow it to be cooled in an advantageous way, so that the risk of burning during the grilling process and shortly after the grilling process is advantageously reduced for the user.

According to a further aspect, the invention relates to a grill system comprising a double-walled grill device, at least one burner device and/or at least one grid and/or a plancha and/or a flame shielding device and/or a grill plate. The at least one burner device is arranged inside the inner grill chamber and below the grid and/or the plancha and/or the flame shielding device and/or the grill plate and can be integrated into the grill device according to the invention in a particularly simple manner. Depending on the application of the grill system, the food to be grilled can be placed on the grid and/or the plancha and/or in the area of the flame shielding device, which can also be designed as an aroma bar, and/or on the grill plate. By means of the grill system according to the invention, thermal energy can be supplied to the food to be grilled in various ways which can thus be prepared in a particularly varied manner. Furthermore, the grill system according to the invention is operated in a particularly energy-efficient manner by the double-walled grill device according to the invention, so that sufficiently high temperatures are generated with a comparatively low energy input.

In a preferred embodiment, it is provided that the grill system has at least one control panel for regulating at least one media supply. In the context of the invention, media supply is preferably to be understood as the supply of a burner gas, so that the amount of burner gas supplied to the grill system and thus to the grill device, and in particular the amount of gas supplied to the burner devices arranged in the grill device, is regulated via the control panel. The control panel can also have instruments for displaying temperature, pressure and/or humidity for areas of the grill system, for example. The control panel can be used to adapt the media supply particularly advantageously to the grilling process carried out with the grill system, so that the grill system according to the invention can be operated in a particularly energy-efficient manner.

Optionally, the grill system has at least one mounting device for a cabinet. The mounting device can preferably be arranged in a lower edge area of the frame body and can, for example, be designed as a projection, an insert or another structural feature. The grill system can therefore be easily connected to a cabinet using the mounting device.

Optionally, it is provided that at least one cabinet is provided below the mounting device. The cabinet can also be designed as a kind of body and/or cabinet module and have castors, doors, drawers, walls, etc. Furthermore, the cabinet can be used to store a media source, such as a gas cylinder, which is concealed, for example, by doors arranged on the cabinet. Other grilling utensils used in connection with the use of the grill system according to the invention can be advantageously stored in the cabinet. As the cabinet is positioned below the mounting device and below the grill device, the grill device can be positioned above the cabinet at an ergonomic height for a user.

Preferably, the grill system has at least one media distribution device with at least two connectors and a line device, wherein the media distribution device can be connected to a media distribution device of another system via the at least two connectors and the line device. In the context of the invention, a connector of the media distribution device can be a plug, a connection device, a coupling, a port or a valve, for example. A hose connector or a plug connector is also understood as a connector in the context of the invention. Line devices can be connected to one another via a connector. Furthermore, the connector can comprise in particular two connector parts adapted to one another, which can be connected, and particularly preferably locked with each other, to establish a media-tight connection. According to the invention, connecting and disconnecting the two connector parts can be done without a tool, for example, in the form of a spring-loaded quick-action coupling. Moreover, the line device of the media distribution device can be, for example, a hose for a medium such as a fluid, in particular a gas, and for the distribution of the at least one medium between the at least two connectors.

A plurality of line devices can be connected to each other via one of the at least two connectors without any loss of medium in the area of a connector. In other words: The connector is designed to be media-tight, as is the line device. The grill system according to the invention is thus supplied with the medium in a particularly simple manner via the at least one medium distribution device and can forward the medium particularly easily.

In the following, preferred embodiments of the double-walled grill device according to the invention and the system according to the invention are explained in more detail with reference to the following figures.

In the Figures:

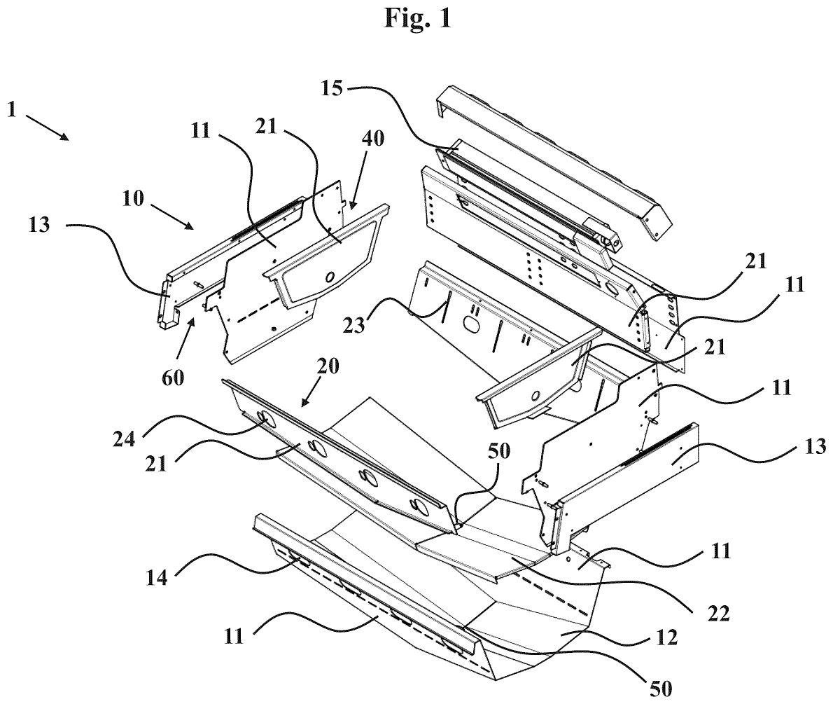

FIG. 1: shows an exploded view of an exemplary embodiment of a double-walled grill device according to the invention,

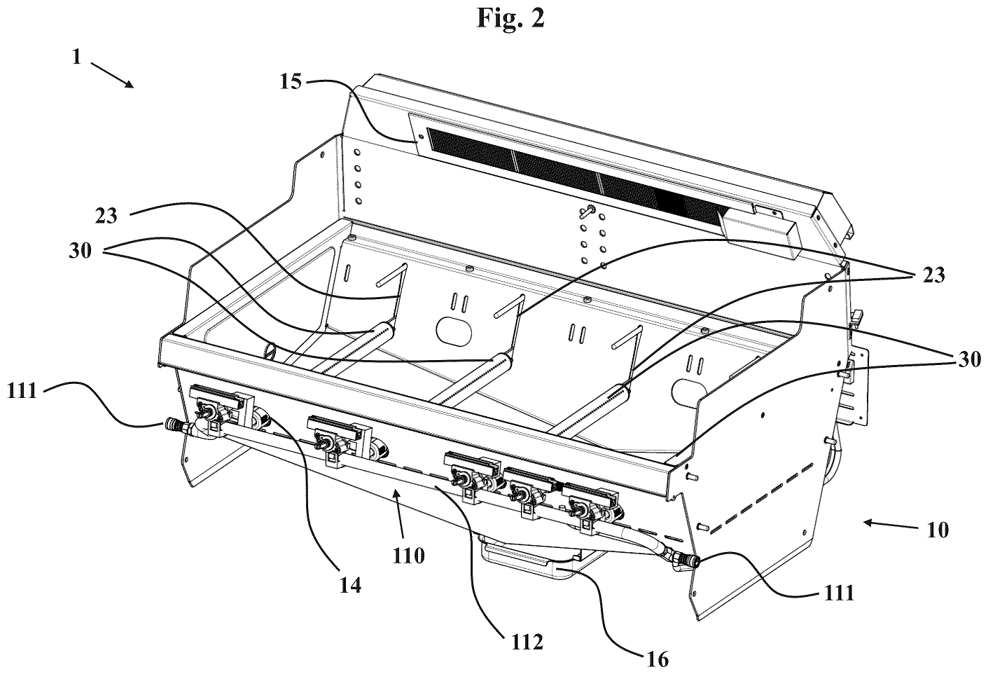

FIG. 2: shows a further schematic representation of the exemplary embodiment of a double-walled grill device according to FIG. 1,

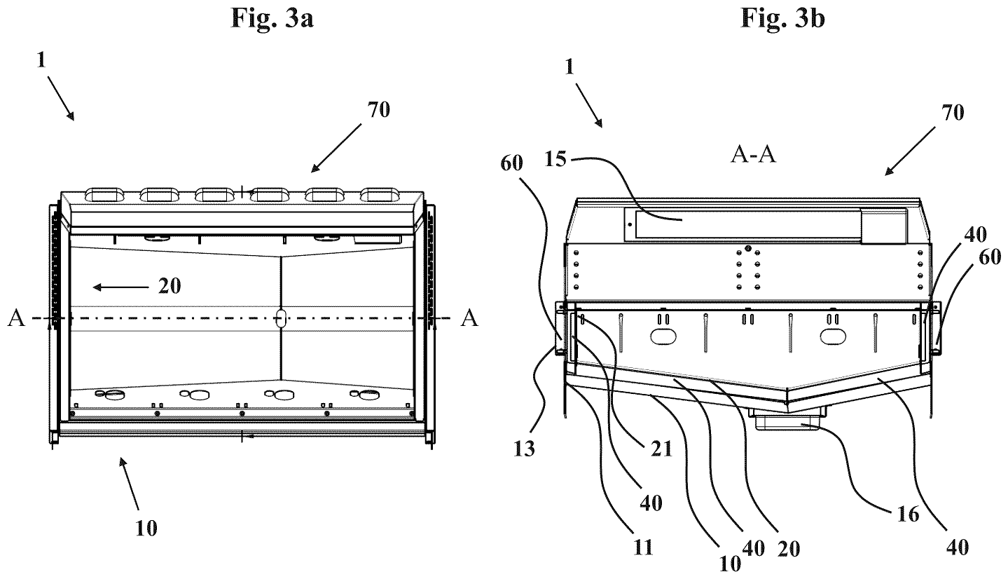

FIG. 3: shows sectional views of an exemplary embodiment of a double-walled grill device,

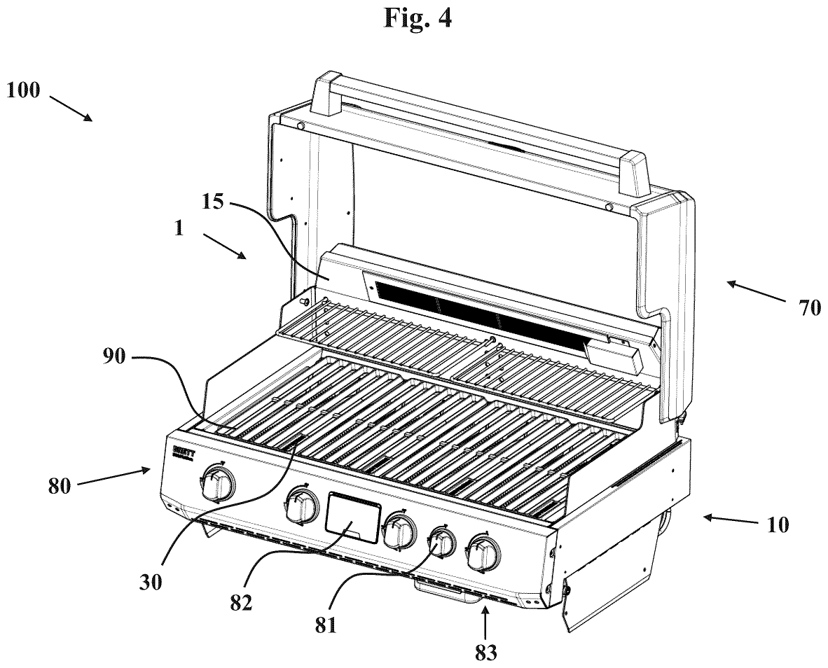

FIG. 4: shows a schematic illustration of an exemplary embodiment of a modular frame for a grill system according to the invention,

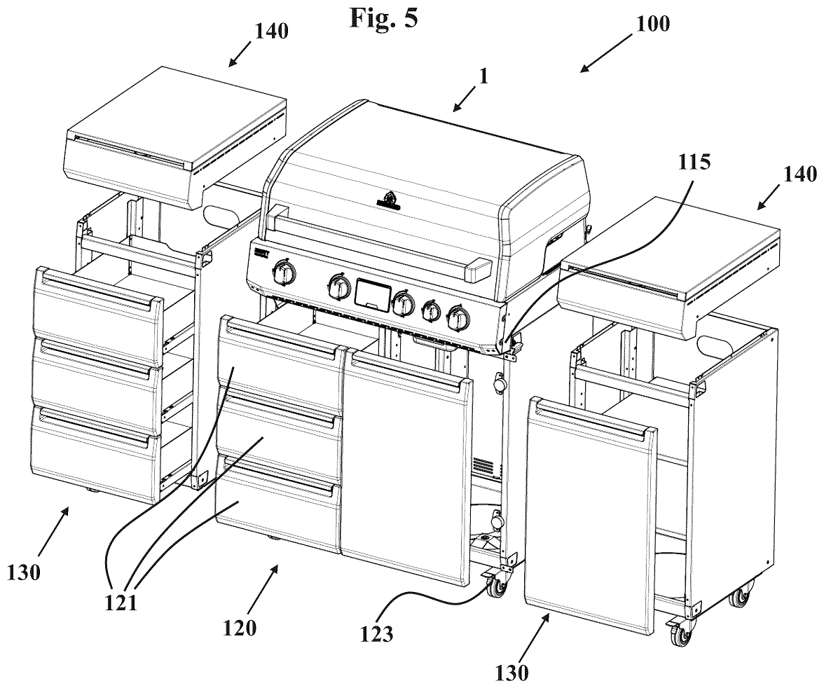

FIG. 5: shows a further schematic illustration of an exemplary embodiment of a modular frame for a grill system according to the invention.

FIG. 1 shows an exploded view of an exemplary embodiment of a double-walled grill device 1 according to the invention with a rectangular outer housing chamber 10 and a rectangular inner grill chamber 20. In the embodiment shown, the outer housing chamber 10 has four outer side elements 11 and an outer base element 12, wherein the outer side elements 11 and the outer base element 12 can be connected to each other via plug-in connections. The inner grill chamber 20, which also has four inner side elements 21 and an inner base element 22, is arranged inside the outer housing chamber 10. The inner side elements 21 and the inner base element 22 can also be connected to each other via plug-in connections. The side elements 11, 21 and/or the base elements 12, 22 can be detached from the grill device 1 according to the invention particularly easily by means of the plug-in connections, so that a defective element can be replaced or a dirty element can be cleaned particularly easily.

A first intermediate space 40 through which air can flow is formed between the outer housing chamber 10 and the inner grill chamber 20, wherein the first intermediate space 40 is formed both between the side elements 11, 21 and between the base elements 12, 22. The intermediate space 40 acts as a thermal insulation device, so that the temperature from the inner grill chamber 20 is only transferred to the outer housing chamber 10 to a small extent. A comparatively high grilling temperature is thus advantageously maintained within the inner grill chamber 20, so that the grill device 1 according to the invention can be operated in a particularly energy-saving manner. Furthermore, the outer housing chamber 10 has a comparatively low temperature, so that the risk of burning on contact with the outer housing chamber 10 is advantageously reduced at the same time.

In the embodiment shown, an additional and optional insulating part 13 is arranged on the outer housing chamber 10. A second space 60, through which air can flow, is formed between the insulating part 13 and the outer housing chamber 10. Similar to the first chamber 40 through which air can flow, the second chamber 60 through which air can flow also forms a thermal insulation device, so that the inner grill chamber 20 is additionally thermally insulated. The insulating part 13 is connected to the outer housing chamber 10 by plug-in elements, for example, so that the insulating part 13 is particularly easy to replace if necessary. The first and second spaces 40, 60 through which air can flow can alternatively or additionally be completely or partially filled with an insulating material, so that the insulating effect of the double-walled grill chamber according to the invention can be reinforced as required.

The comparatively high temperature inside the inner grill chamber 20 can be generated by at least one burner device 30 (not shown in FIG. 1). This can be arranged in a particularly simple way via a first opening 24 and a first recess 23 in the area of the inner grill chamber 20 and fixed there. One end of the burner device 30 can partially protrude from the outer housing chamber 10 via a second opening 14 of the outer housing chamber 10, so that, for example, the burner device 30 can be supplied with a burner medium, for example a burner gas, via this end. The burner device 30 is fixed via the first recess 23 on the side facing away from the user and is floatingly mounted via the first opening 24 on the side facing the user. The second opening 14 and the first opening 24 are arranged opposite the recess 23. Since the at least one burner device 30 is mounted floating, it is on the one hand arranged in a radially stable manner in the grill device 1 and on the other hand arranged with sufficient axial play, so that the burner device is not jammed in the grill device 1 even due to material-related expansion at higher temperatures.

Furthermore, the recess 23 makes it particularly easy to remove the burner device 30 from the grill device 1, for example for cleaning and/or maintenance purposes.

In the embodiment shown, the inner base element 22 of the inner grill chamber 20 and the outer base element 12 of the outer housing chamber 10 each have an opening 50. This is designed as an outlet or drainage opening so that, for example, moisture or liquid residues that arise during a grilling process can flow out of the inner grill chamber 20 and/or the outer housing chamber 10. The openings 50 are also arranged almost flush with each other so that the residue can drain off particularly well. A container for collecting the liquid grill residue can also be arranged below the opening 50 of the outer housing chamber 10. Unwanted residues are therefore not accumulated within the inner grill chamber 20 and/or within the outer housing chamber 10 of the grill device 1. In the embodiment shown, the inner base element 22 and the outer base element 12 are inclined downwards in the direction of the openings 50 in order to encourage the residues to flow off. By draining liquid fat from the inner grill chamber 20, a possible fat fire is also prevented in an advantageous manner. The grill device 1 according to the invention is thus kept clean in a particularly advantageous manner even when used intensively.

In the embodiment shown, a rear burner 15 is arranged above and along an edge area of the outer housing chamber 10 and the inner grill chamber 20. By arranging the rear burner 15, a particularly temperature-intensive grilling process can be achieved along an edge area of the outer housing chamber 10, so that the food to be grilled, which is arranged in this area, is additionally supplied with heat energy on the longitudinal side in a particularly advantageous way. The rear burner 15 is inclined in the direction of the inner grill chamber 20, so that the heat energy radiates onto the food at an advantageous angle. The inclination of the rear burner 15 can be adjusted in order to direct the heat radiation specifically and flexibly onto the food to be grilled.

FIG. 2 shows a schematic representation of the exemplary embodiment of the double-walled grill device according to FIG. 1, wherein a media distribution device 110 is arranged on the longitudinal side facing the user. The media distribution device 110 has two connectors 111, via which the double-walled grill device 1 according to the invention can, for example, receive and forward a medium. The medium is also fed to the four burner devices 30 through a line device 112. In the illustrated embodiment, each of the four burner devices 30 is arranged through a second opening 14 of the outer housing chamber 10 and locked in the first recess 23 of the inner grill chamber. In the grill device 1 according to the invention, the burner devices 30 can be removed in a particularly simple manner, for example for cleaning purposes.

A container 16 designed as a fat drawer is arranged below the outer housing chamber 10 and can be used to collect residues, such as liquid fat, which flow out of the opening 50 during or after the grilling process. The container 16 allows to easily collect unwanted residues without soiling the grill device 1. Furthermore, the collection by the container 16 prevents soiling of the areas below the grill device 1, so that additional cleaning effort for these areas is advantageously reduced.

FIG. 3 shows a sectional view of an exemplary embodiment of a double-walled grill device, with FIG. 3a showing a top view of the double-walled grill device 1 with the cover 70 open. The inner grill chamber 20 is located inside the double-walled grill device 1 and the outer housing chamber 10 is located outside. Further, the sectional plane A-A is shown which is arranged parallel to the longitudinal sides and in the middle of the double-walled grill device 1.

The sectional view of plane A-A shown in FIG. 3b according to FIG. 3a shows a sectional view of the double-walled grill device 1 from the front side facing the user, so that the user is facing the rear burner 15 frontally, for example. This view also shows the arrangement of the container 16 below the outer housing chamber 10.

The view shown in FIG. 3b makes the double-walled design of the grill device 1 according to the invention particularly clear: Between the inner side element 21 of the inner grill chamber 20 and the outer side element 11 of the outer housing chamber 10, there is a first intermediate space 40 through which air can flow. This first intermediate space 40 thermally insulates the inner grill chamber 20, so that the double-walled grill device 1 according to the invention is operated in an energy-efficient manner.

In addition, in the embodiment shown, an insulating part 13 is arranged outside the outer side element 11 of the outer housing chamber 10, forming a second intermediate space 60 through which air can flow. The previously described insulating and efficiency-enhancing effect of the first intermediate space 40 is reinforced by the second intermediate space 60, so that the grill device 1 shown can be operated in a particularly energy-efficient manner. Of course, the first and second intermediate spaces 40, 60 can also be arranged on the longitudinal sides and in regions of the base elements 12, 22 of the grill device 1, so that, for example, almost the entire inner grill chamber is surrounded by intermediate spaces through which air can flow.

FIG. 4 shows a schematic illustration of an exemplary embodiment of a modular frame for a grill system 100 according to the invention. In addition to the grill device 1 according to the invention, the illustrated grill system 100 has a hinged cover 70 arranged on the outer housing chamber 10 for partially or completely covering the upper opening of the inner grill chamber 20 and the outer housing chamber 10.

Outside the outer housing chamber 10, a control panel 80 is arranged on a longitudinal side of the grill device 1, by means of which the four burner devices 30 in the embodiment shown are operated separately via four controllers or setting devices. Furthermore, the control panel 80 shown has an additional controller 81 and a display 82, for example to show the current temperature inside the inner grill chamber or to indicate the fill level of a media source. Furthermore, the control panel 80 has ventilation inlets 83 in the lower area, whereby the control panel 80 is advantageously ventilated from behind, so that the risk of burning during the grilling process and shortly after the grilling process is advantageously reduced for the user.

Above the burner devices 30, the grill system 100 according to the invention has a grid 90 on which the food can be positioned during the grilling process. Furthermore, the grill system 100 has a double-walled grill device 1 with a rear burner 15, so that in addition to the burner devices 30, further thermal energy can be supplied to the food being grilled on the longitudinal side.

By means of the grill system 100 according to the invention, thermal energy can thus be supplied to the food to be grilled in various ways which can thus be prepared in a particularly varied manner. Furthermore, the grill system 100 according to the invention is operated in a particularly energy-efficient manner by the double-walled grill device 1 according to the invention, so that sufficiently high temperatures are generated with a comparatively low energy input.

FIG. 5 shows a further schematic representation of an exemplary embodiment of a grill system 100 according to the invention, wherein a cabinet 120 is arranged below the grill device 1 via a receiving device 115. The mounting device 115 is arranged in a lower area of the grill device 1 and is designed as a projection.

In the embodiment shown, the cabinet 120 is designed as a cabinet module, which has several pull-out drawers 121 and castors 123 arranged in the floor area, so that the cabinet 120 can be moved particularly easily with the grill system 100. The drawers 121 can be used to store a media source, for example a gas cylinder, so that it is concealed, or to store grilling utensils so that they are always within reach for the user.

Furthermore, in the embodiment shown, an additional cabinet 130 is arranged at the side of the cabinet 120, which can be used, for example, as a refrigerator cabinet for storing grilled food or beverages. A further additional module 140 is arranged above each additional cabinet 130. This can, for example, also be supplied with the medium via the media distribution device 110 (not shown) of the grill device 1 of the grill system 100 and can, for example, be designed as a cooking module, ceramic burner module, wok module, etc.

The illustrated embodiment of the grill system 100 according to the invention thus offers, in addition to the energy-efficient operation of the grill device 1, the possibility of storing grilling utensils and the option of modular extensions via additional cabinets 130 and additional modules 140, so that the grill system 100 can be operated in a particularly advantageous manner.

### LIST OF REFERENCE NUMERALS

1 double-walled grill device
10 outer housing chamber
11 outer side element
12 outer base element
13 insulating part
14 second opening
15 rear burner
16 container
20 inner grill chamber
21 inner side element
22 inner base element
23 first recess
24 first opening
30 burner device
40 first intermediate space
50 opening
60 second intermediate space
70 cover
80 control panel
90 grid
100 grill system
110 media distributing device
111 connector
112 line device
115 mounting device
120 cabinet
130 additional cabinet
140 additional module

1. A double-walled grill device (1) comprising:
a trough-shaped outer housing chamber (10) open at the top; and
a trough-shaped inner grill chamber (20) open at the top;
wherein the inner grill chamber (20) is designed to receive at least one burner device (30) and the inner grill chamber (20) is designed to be arranged within the outer housing chamber (10); and
wherein, when the inner grill chamber (20) is arranged within the outer housing chamber (10), at least a first intermediate space (40) through which air can flow is formed between the inner grill chamber (20) and the outer housing chamber (10).

2. The double-walled grill device according to claim 1, wherein the outer housing chamber (10) comprises at least one outer side element (11) and at least one outer base element (12) and/or in that the inner grill chamber (20) comprises at least one inner side element (21) and at least one inner base element (22).

3. The double-walled grill device according to claim 2, wherein the outer side element (11) is adapted to be connected to the outer base element (12) and/or in that the inner side element (21) is adapted to be connected to the inner base element (22).

4. The double-walled grill device according to one of the preceding claims, wherein the outer housing chamber (10) has at least one ventilation inlet for supplying cold air into the first intermediate space (40).

5. The double-walled grill device according to claim 2, wherein the outer base element (12) of the outer housing chamber (10) and/or the inner base element (22) of the inner grill chamber (20) are provided with at least one opening (50), in particular at least one outlet opening.

6. The double-walled grill device according to claim 2, wherein the inner side element (21) and/or the inner base element (22) has/have a plurality of wall elements, via which the inner grill chamber (20) is adapted to be supported at a distance in the outer housing chamber (10).

7. The double-walled grill device according to any one of claims 1 to 3, wherein the outer housing chamber (10) and/or the inner grill chamber (20) enclose a grill chamber space which becomes larger in the vertical direction towards the top.

8. The double-walled grill device according to any one of claims 1 to 3, wherein at least one insulating part (13) is arranged on the outer housing chamber (10), at least one second intermediate space (60) through which air can flow being formed between the at least one insulating part (13) and the outer housing chamber (10).

9. The double-walled grill device according to claim 2 or 3, wherein the inner base element (22) is arranged rising from a central region in the direction of the inner side element (21) and/or the outer base element (12) is arranged rising from a central region in the direction of the outer side element (11).

10. The double-walled grill device according to one of the claims 1 to 3, wherein the inner grill chamber (20) has at least one first recess (23) for fixing and at least one first opening (24) for floatingly supporting at least one burner device (30), the at least one first recess (23) and the at least one first opening (24) being arranged opposite one another.

11. The double-walled grill device according to one of the claims 1 to 3, wherein the outer housing chamber (10) comprises at least one second opening (14), wherein the at least one second opening (14) is preferably adapted to the at least one first opening (24) for floatingly supporting the at least one burner device (30) of the inner wall.

12. The double-walled grill device according to one of the claims 1 to 3, wherein a cover (70) is pivotably arranged on the outer housing chamber (10) for partially or completely covering the upper opening of the inner grill chamber (20) and/or the outer housing chamber (10).

13. The double-walled grill device according to one of the claims 1 to 3, wherein the cover (70) has at least one double-walled wall having a further intermediate space, the further intermediate space preferably being filled with an insulating material.

14. The double-walled grill device according to one of the claims 1 to 3, wherein a control panel (80) having further ventilation inlets is arranged outside the outer housing chamber (10).

15. A grill system (100) comprising:
a double-walled grill device (1) according to claim 1, and
at least one burner device (30) and/or
at least one grid (90) and/or a plancha and/or a flame shielding device and/or a grill plate.

16. The grill system according to claim 15, wherein the grill system has at least one control panel (80) for regulating at least one media supply.

17. The grill system according to claim 15, wherein the grill system has at least one media distribution device (110) with at least two connectors (111) and a line device (112),
wherein the media distribution device (110) is adapted to be connected to a media distribution device (110) of a further system via the at least two connectors (111) and the line device (112).
